(19) United States
(12) Patent Application Publication
(10) Pub. No.: US 2005/0198558 A1
(43) Pub. Date: Sep. 8, 2005

(54) Method and apparatus for proofing a scan job

(76) Inventors: Roy K. Chrisop, Camas, WA (US); Ginger Marie Finnegan, Manhattan Beach, CA (US); Tanna Marie Richardson, Happy Valley, OR (US)

Correspondence Address: BIRDWELL & JANKE, LLP, 1100 SW SIXTH AVENUE, SUITE 1400, PORTLAND, OR, 97204, US

(21) Appl. No.: 10/786,278

(22) Filed: Feb. 24, 2004

(51) Int. Cl. G06F 15/00

(52) U.S. Cl. 715/500

(57) ABSTRACT

A method and apparatus for proofing a scan job. In a preferred embodiment of the invention, a plurality of pages have been scanned using a scanner adapted for printing. A proof sheet is printed by the scanner. The proof sheet contains a selected sub-set of the information contained within the scan job. A user inspects the proof sheet and elects, based on the inspection, whether to accept the scan job or not. Where the result of said step of electing is to accept the scan job, the scan job is thereafter sent, preferably by being forwarded to a network. Preferably the scan job is stored in a memory and, where the user elects not to accept the scan job, the stored scan job is modified according to user instruction prior to being sent.

### FIELD OF THE INVENTION

The present invention relates to a method and apparatus for proofing a scan job. More particularly, the present invention relates to such a method and apparatus for use with a multi-function peripheral connected to a computer network.

### BACKGROUND

Scanners have traditionally been provided as peripherals to PC's. One or more scanned documents or images can be stored in the PC as files and displayed on the display of the PC or printed on a local printer. If the PC is networked, the scanned document or image files can be accessed by other devices on the network.

More recently, network scanners have been provided. A network scanner is capable of being networked. Often, the network scanner is provided with document handling and feeding capabilities so that multiple documents can be scanned automatically, and the typical network scanner provides the features of the traditional office copy machine.

Network scanners have also been provided as part of more general “multi-function peripherals” (“MFP's”) that can provide image output, e.g., printed documents, as well as receive image input, e.g., scanned documents.

Users of scanners and MFP's often need to verify a scanned document or documents before sending them to their final destination on the network. This need arises for a number of reasons. For example, users may be unsure in advance of the scanner settings, e.g., resolution, darkness, etc., necessary to produce a desired image quality. Color scans may benefit particularly from image enhancements such as darkness control made in advance of sending the scan.

Also, document feeders in different machines differ as to their requirements for placing pages to be scanned. For example, some scanners require face-up placement, while others require face-down placement. Document feeders may also differ in the required orientation of the document. Accordingly, users who are not familiar with a particular scanner often need to verify that they have scanned the correct side of a document and that the document is in the correct orientation.

The documents themselves may be of poor physical quality and this can result in scanning difficulties. For example, if documents are not crisp and straight, the document feeder may mishandle the documents such that the scanned images are rotated, or the scanner may not be able to focus properly on the document, resulting in poor image quality. Moreover, document mis-feeds may cause one or more pages not to be scanned, so that the scan job will have missing pages.

Users currently proof scan jobs by sending the scans to their desk-top PC's, which are typically in another room, for display on the screen of the PC. The documents must typically be viewed one page at a time. If the user deems the job unsatisfactory, the user must return to the scanner and rescan the document with corrections and repeat the process.

Software has been provided that allows users to preview thumbnails of the scanned images on a screen. However, providing a screen of sufficient size and resolution to permit proofing image quality in the network scanner is expensive. If the scanner is connected to a PC, the display in the PC could be used, but a stand-alone network scanner may not be near a PC or other display device.

Accordingly, there is a need for a method and apparatus for proofing a scan job that provides the functionality users desire conveniently and at low cost.

### SUMMARY OF THE INVENTION

The invention pertains to a method and apparatus for proofing a scan job. In a preferred embodiment of the invention, a plurality of pages have been scanned using a scanner adapted for printing. A proof sheet is printed by the scanner. The proof sheet contains a selected sub-set of the information contained within the scan job. A user inspects the proof sheet and elects, based on the inspection, whether to accept the scan job or not. Where the result of said step of electing is to accept the scan job, the scan job is thereafter sent, preferably by being forwarded to a network. Preferably the scan job is stored in a memory and, where the user elects not to accept the scan job, the stored scan job is modified according to user instruction prior to being sent.

### DESCRIPTION OF THE DRAWINGS

FIG. 1 is a pictorial view of a multi-function peripheral according to the present invention.

FIG. 2 is a block diagram of the multi-function peripheral of FIG. 1 connected to a network.

FIG. 3 is a pictorial view of a scan job proof sheet according to the present invention.

FIG. 4 is a pictorial view of an interface panel for the multi-function peripheral of FIG. 1.

FIG. 5 is a schematic view of a user interface implemented in the interface panel of FIG. 4.

FIG. 6 is a flow diagram of a preferred method for proofing a scan job according to the present invention.

FIG. 7 is a pictorial flow diagram showing selected steps of the method of FIG. 6.

### DETAILED DESCRIPTION

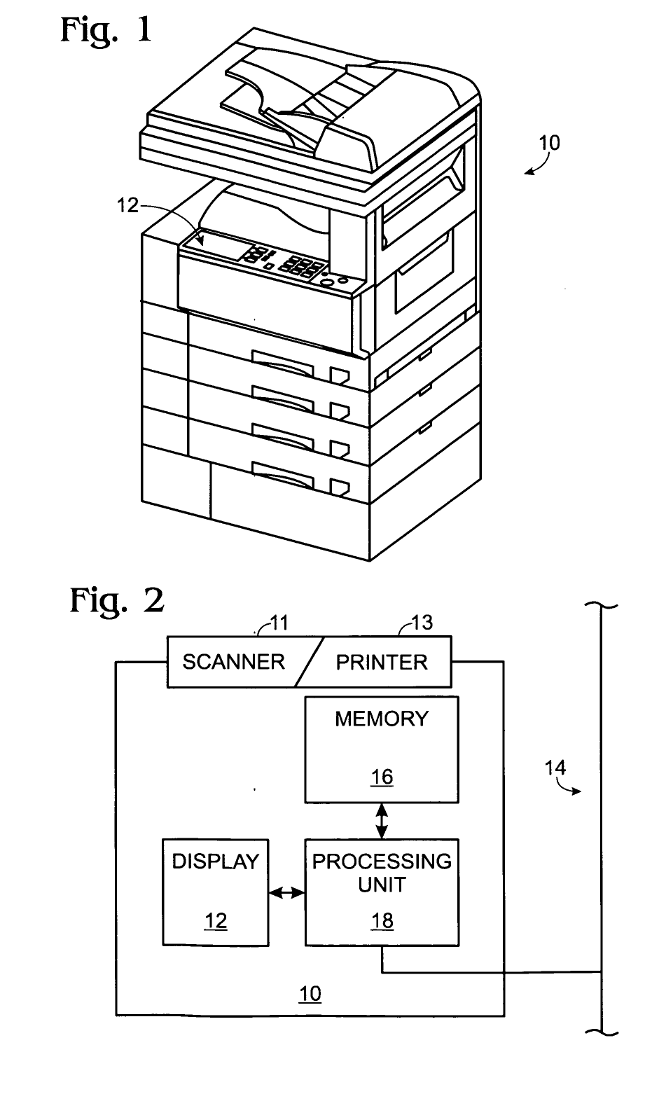

FIG. 1 shows a typical multi-function peripheral (“MFP”) 10. The MFP provides for multiple peripheral functions, such as scanning, printing, and faxing. The MFP 10 has a display panel 12, e.g., an LCD array, for displaying information to a user of the device. The display panel 12 is typically provided as a touch screen to permit the user to interface with the MFP.

Turning to FIG. 2, the MFP 10 is typically connected to a network 14 and will be described in that context, however, it should be understood that the MFP may also be used as a dedicated peripheral for a local host, such as a PC. The MFP includes a scanner 11, a printer 13, and a central processing unit 18. The MFP further includes a system memory 16 for storing scanned images received from the scanner 11. The stored images are forwarded to the network 14 by the processing unit 18 for distribution to a network destination, e.g., computers or other peripherals connected to the network. For example, remote computers, remote peripherals, and hand held devices such as PDA's and cell phones may be connected to the network, and distribution of the scan job may be for purposes of faxing, Internet-faxing (“I-faxing”), e-mailing, or saving to a file, ultimately for rendering the scan job on a display or in print.

The stored images may also be forwarded internally to the MFP; for example, where the MFP includes faxing capability, the stored images may be forwarded internally for such processing by the processor 18 as is necessary to prepare the images for faxing. The stored images may also be forwarded internally to the MFP for printing with the printer 13, e.g., for using the MFP as a copy machine.

The processing unit 18 is further adapted to execute a program of instructions to perform the functions disclosed herein. The program of instructions may be provided in software, hardware, or any combination thereof. Where provided in software, the instructions may be embodied in any removable or fixed medium, such as a CD-ROM, hard disk, memory or PLA.

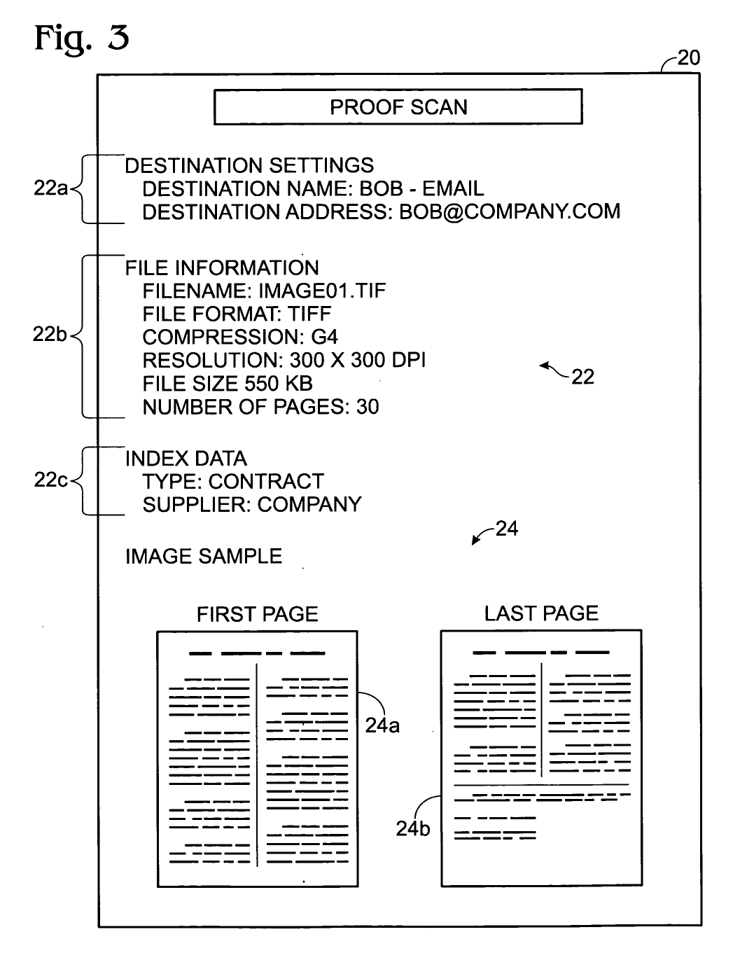

The MFP 10 provides a novel means for proofing a scan job. A scan job for purposes herein is one or more scanned documents. A document may have one or more individual pages or sheets of paper as printed. Referring to FIG. 3, according to the invention, the MFP 10 outputs, i.e., prints, a “proof sheet” 20 representative of the scan job. The proof sheet 20 contains a selected sub-set of the information contained within the scan job. Selection of the sub-set is made so as to efficiently facilitate the user's decision either to forward a given scan job to the network as is or rework the scan job prior to forwarding. The proofing process may be repeated as many times as is desired to ensure the user's satisfaction before a scan job is forwarded from the memory 16 of the MFP to the network 14.

More particularly, the proof sheet 20 bears two different types of information: (1) descriptive information 22; and (2) image information 24. Examples of descriptive information are destination information 22a that is descriptive of the destination for the scan job, file information 22b that is descriptive of the scan job itself, and reference information 22c that is descriptive of context or background. The information 22 shown is exemplary and not intended to be exhaustive.

Preferred image information 24 is one or more thumbnail images representing one or more respective pages of the scan job. Preferably, just the first and last pages 24a and 24b of the scan job are copied as illustrated, but fewer, other or additional pages may be selected as desired. The image information is preferably less than the total amount of image information in the scan job, however, all of the information may be printed if desired without departing from the principles of the invention. For example, thumbnail images of the first and last pages 24a and 24b may be used to represent a scan job having three or more pages, to permit the user to assess the acceptability of the scan job without having to inspect all of the pages. Thumbnail images may also be provided of every page in the scan job, permitting the user the option of inspecting every page. It should be appreciated that providing thumbnail images of all of the pages of a scan job nevertheless provides only a sub-set of the information contained within the print job, since each thumbnail image is a compressed form of the full image.

The proof sheet 20 may be one or more printed pages. Where a proof sheet having more than one page is used to represent the scan job, most or all of the descriptive information 22 may advantageously be omitted from all but one of the pages.

The amount of space on the proof sheet 20 devoted to image information 24 is preferably as to be as large as practical in relation to the space devoted to descriptive information 22 to enhance the user's ability to visually inspect the quality of the image information. The image information may also be distorted or rotated as desired in order to fit the image information to the page in a way that maximizes this utility, however, typically, the image information is most usefully presented in scaled, WYSIWYG (“what-you-see-is-what-you-get”) form such as shown.

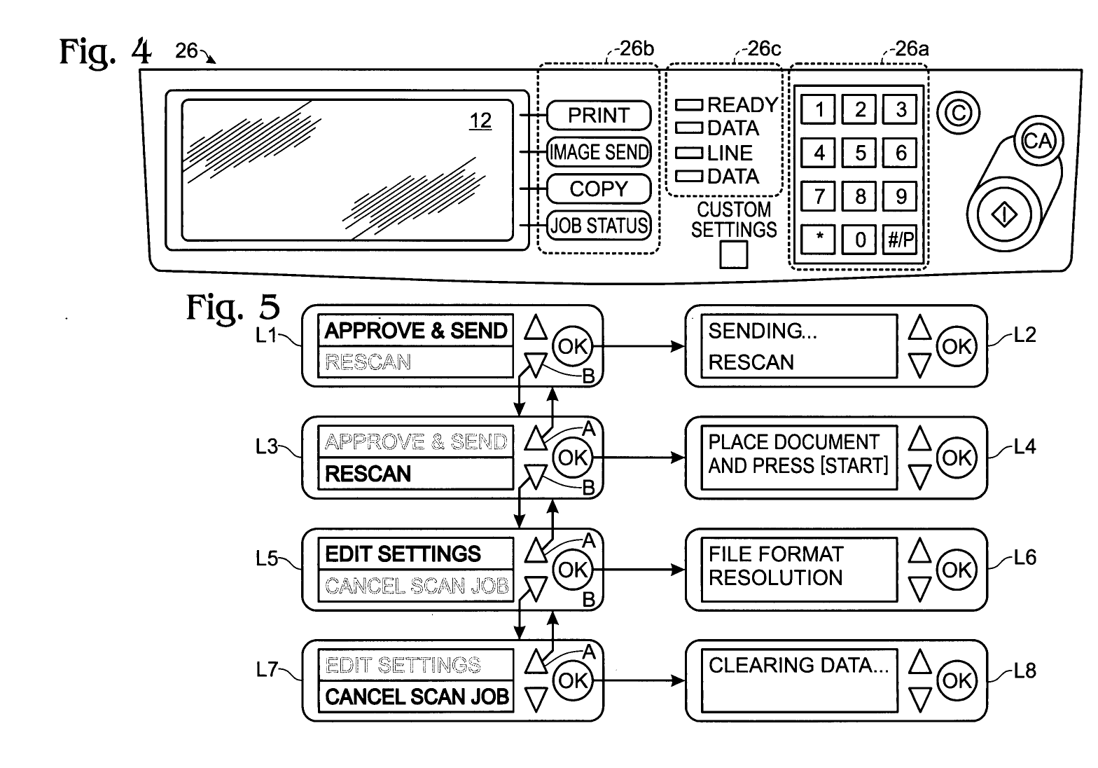

Turning to FIG. 4, a typical interface panel 26 for the MFP 10 is shown. The aforementioned display panel 12 is part of the interface panel, along with dedicated keypads for entering data (e.g., at 26a) and instructions (e.g., at 26b). The interface panel 26 also includes status indicators (e.g., at 26c).

The display panel 12 is preferably used by a user, according to the invention, to instruct the MFP 10 to implement proofing schemes according to the invention. FIG. 5 shows a schematic view of a typical user interface implemented in the display panel 12 of the interface panel 26. The Figure shows the display 12 at various levels L1, L2, . . . L8.

The user inspects the proof sheet 20 and, at the level L1 of the display panel 12, the user is provided the option of approving and sending the scan job. Touching the keypad “OK” at the level L1 indicates approval of the scan job which is forwarded to the network 14 for sending the scan job to a remote computer or computer peripheral connected to the network. The display panel transitions to the level L2 to indicate that the job is being sent.

Alternatively, touching the keypad B at the level L1 causes the display panel 12 to transition to the level L3, providing the option of rescanning the scan the job. Touching the keypad “OK” at the level L3 causes the display panel to transition to the level L4 instructing the user to place the document in the document input of the MFP and to take action to start the rescanning.

Alternatively, touching the keypad B at the level L3 causes the display panel 12 to transition to the level L5, providing the user the option of editting settings for the scan job. Touching the keypad “OK” at the level L5 causes the display panel to transition to the level L6 which provides settings from which the user may choose. Just two settings are shown in FIG. 5 as exemplary, however, it will be readily appreciated that a complete settings menu may be provided, preferably the standard settings menu for the MFP.

Alternatively, touching the keypad B at the level L5 causes the display to transition to the level L7, providing the user the option to cancel the scan job. Touching the keypad “OK” causes the display to transition to the level L8 indicating that cancellation of the scan job, e.g., by erasing all or part of the system memory 16, is proceeding.

Touching the keypad A at any of the levels L3, L5, or L7 causes the display 12 to transition to the levels L1, L3, or L5, respectively, to return the user to a prior option.

As will be appreciated by persons of ordinary skill, the simple interface described above in connection with FIG. 5 may be embellished as desired to include additional functionality as well as additional graphic appeal. It should also be understood that the structure and order of the interface may be altered as desired. The invention may also provide for rescanning selected pages or parts of a document or scan job with suitable modification of the level L4.

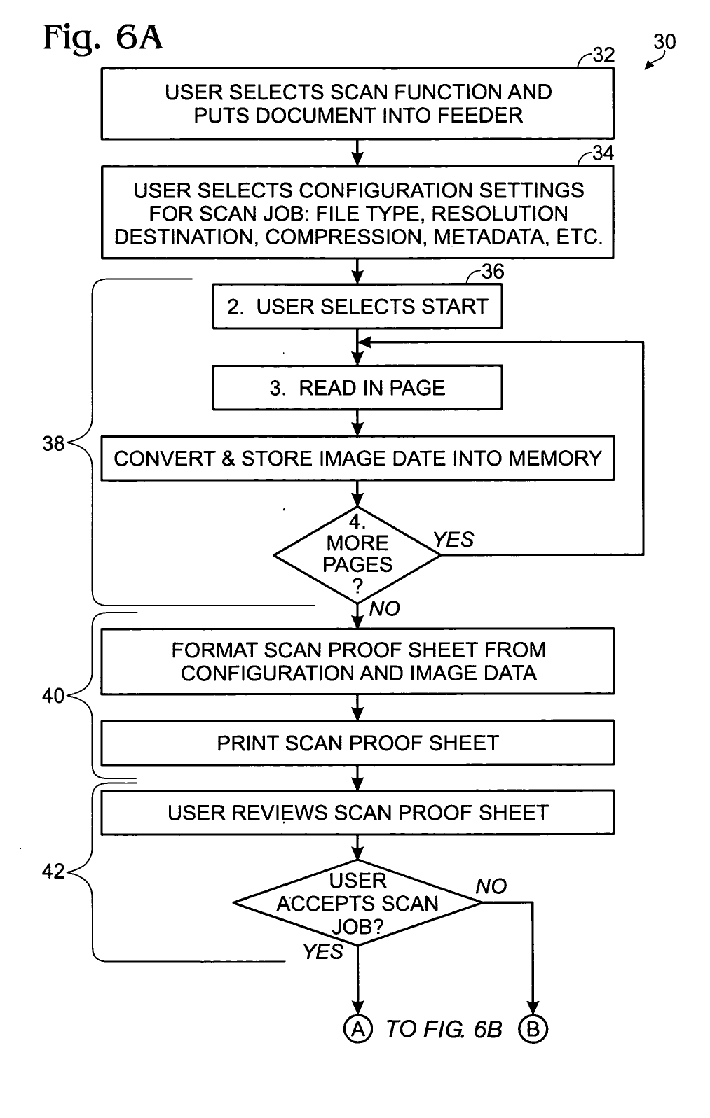

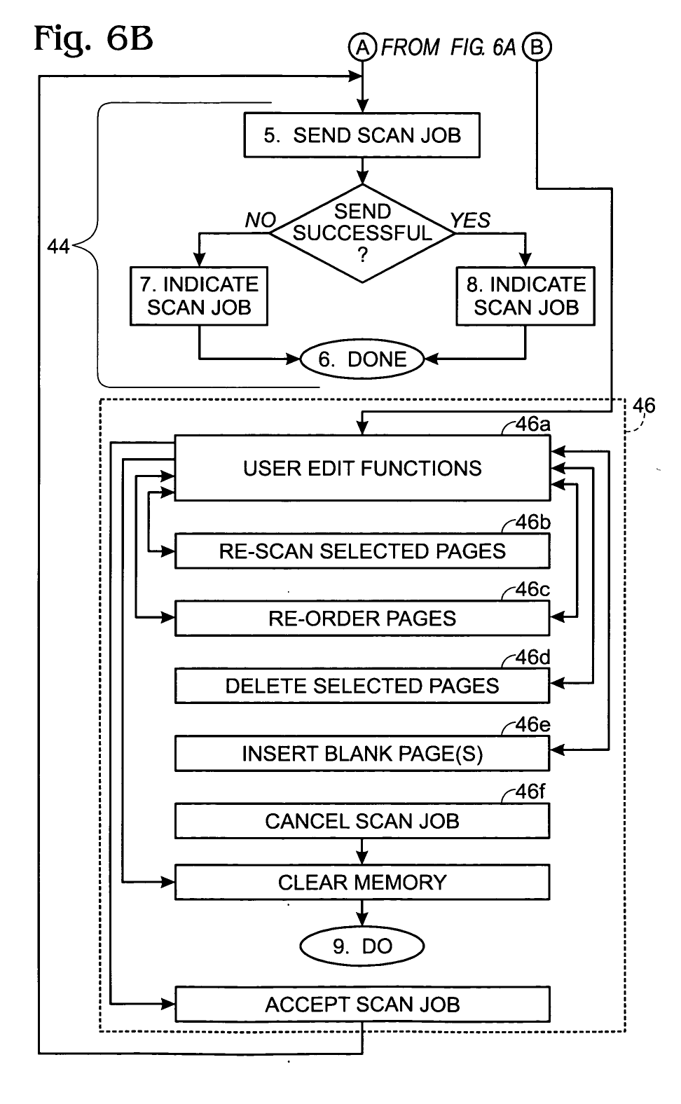

FIG. 6 is a flow diagram of a preferred method 30 for proofing a scan job according to the present invention. The user selects a “Scan” function in step 32 and places one or more documents defining a scan job into a feeder of the MFP 10. The user selects configuration settings for the scan job such as file type, resolution, destination, compression, Metadata, etc. in step 34. The user instructs the MFP 10 to “Start” the scan in step 36, and the MFP reads the scan job page by page in step 38, converting the scanned image to digital data and storing the digital data in the system memory 16.

When all of the pages are scanned and the data representative thereof are stored, a proof sheet according to the invention is created and printed in step 40. The user inspects the proof sheet and either accepts the scan job or rejects the scan job, at step 42.

If the scan job is accepted, the user instructs the MFP 10 to “Send” the scan job to a destination at step 44. However, if the user does not accept the scan job, the invention provides for a step 46 in which the user may revise the scan job by, for example, editting settings for the scan job (46a), re-scanning selected pages (46b), re-ordering pages (46c), deleting selected pages (46d), inserting blank pages (46e), or cancelling the scan job (46f). If the entire scan job has not been deleted, the user may complete the scan job in step 46 by sending the scan job in its revised form to step 44.

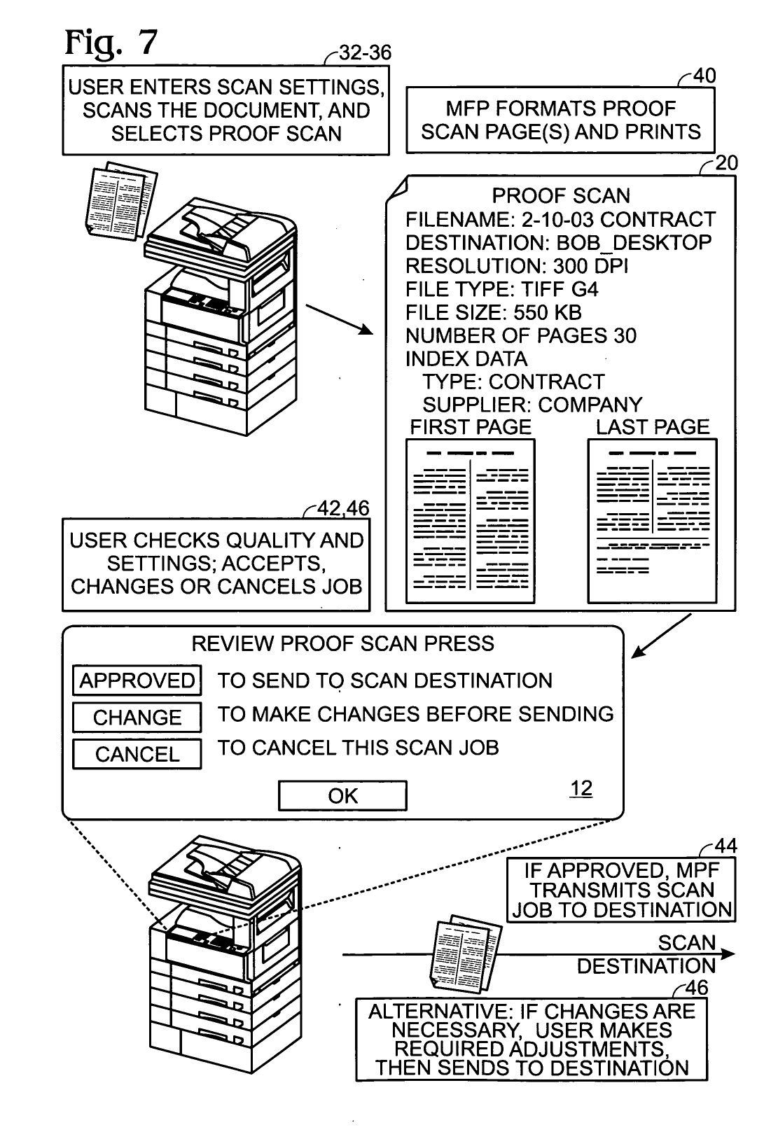

FIG. 7 is a pictorial flow diagram showing selected steps of the method 30, emphasizing the outstanding simplicity of the method from the user's point of view.

It is to be recognized that, while preferred methods and apparatus according to the present invention have been shown and described, other methods and apparatus incorporating one or more of the features described herein may be employed without departing from the principles of the invention. For example, while described herein in the context of an MFP connected to a network for sending a scan job to a network destination, the invention may be used in connection with any scanning device adapted for printing, including stand-alone (non-networked) devices or devices connected to a local computer or peripheral.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A method for proofing a scan job in which a plurality of pages have been scanned using a scanner adapted for printing, comprising:
printing a proof sheet by the scanner, said proof sheet containing a selected sub-set of the information contained within the scan job;
inspecting said proof sheet;
electing, based on the result of said step of inspecting, whether to accept the scan job or not; and
where the result of said step of electing is to accept the scan job, thereafter sending the scan job.

2. The method of claim 1, further comprising rendering substantially the entire scan job after said step of sending.

3. The method of claim 1, wherein said proof sheet includes one or more thumbnail images representing one or more respective pages of the scan job.

4. The method of claim 3, wherein said proof sheet includes descriptive information describing the scan job.

5. The method of claim 3, wherein said step of sending includes forwarding the scan job to a network.

6. The method of claim 1, wherein said step of sending includes forwarding the scan job to a network.

7. The method of claim 1, wherein the network includes at least one of the following: a remote computer, a remote computer peripheral, and a hand-held device.

8. The method of claim 1, wherein, where the result of said step of electing is not to accept the scan job, the method further comprising the step of storing the scan job in a memory, receiving user instruction, and modifying the stored scan job according to said user instruction prior to said step of sending.

9. The method of claim 8, wherein said proof sheet includes one or more thumbnail images representing one or more respective pages of the scan job.

10. The method of claim 9, wherein said step of sending includes forwarding the scan job to a network.

11. The method of claim 10, further comprising rendering substantially the entire scan job after said step of forwarding.

12. An apparatus for proofing a scan job, comprising:
a scanner adapted for printing; and
a processing unit adapted to (a) cause said scanner, where a plurality of pages have been scanned using said scanner, to print a proof sheet, said proof sheet containing a selected sub-set of the information contained within the scan job, (b) provide for user election whether to accept the scan job or not, and (c) where the user elects to accept the scan job, thereafter send the scan job.

13. The apparatus of claim 12, wherein said proof sheet includes one or more thumbnail images representing one or more respective pages of the scan job.

14. The apparatus of claim 13, wherein said proof sheet includes descriptive information describing the scan job.

15. The apparatus of claim 13, wherein said processing unit is adapted to send the scan job at least by forwarding the scan job to a network.

16. The apparatus of claim 12, wherein said processing unit is adapted to send the scan job at least by forwarding the scan job to a network.

17. The apparatus of claim 12, wherein the network includes at least one of the following: a remote computer, a remote computer peripheral, and a hand-held device.

18. The apparatus of claim 12, further comprising a memory, wherein, where the user elects riot to accept the scan job, the processing unit is adapted to store the scan job in said memory, receive user instruction, and modify the stored scan job according to said user instruction prior to sending the scan job.

19. The apparatus of claim 18, wherein said proof sheet includes one or more thumbnail images representing one or more respective pages of the scan job.

20. The apparatus of claim 19, wherein said processing unit is adapted to send the scan job at least by forwarding the scan job to a network.

21. A medium readable by a machine embodying a program of instructions executable by the machine to perform a method for proofing a scan job in which a plurality of pages have been scanned using a scanner adapted for printing, comprising:
printing a proof sheet by the scanner, said proof sheet containing a selected sub-set of the information contained within the scan job;
where a user inspects said proof sheet, receiving user input indicating whether the user elects to accept the scan job or not; and
where the user elects to accept the scan job, thereafter sending the scan job.

22. The medium of claim 21, wherein said proof sheet includes one or more thumbnail images representing one or more respective pages of the scan job.

23. The medium of claim 22, wherein said proof sheet includes descriptive information describing the scan job.

24. The medium of claim 22, wherein said step of sending includes forwarding the scan job to a network.

25. The medium of claim 21, wherein said step of sending includes forwarding the scan job to a network.

26. The medium of claim 21, wherein the network includes at least one of the following: a remote computer, a remote computer peripheral, and a hand-held device.

27. The medium of claim 21, wherein, where the user elects not to accept the scan job, the method further comprising the step of storing the scan job in a memory, receiving user instruction, and modifying the stored scan job according to said user instruction prior to said step of sending.

28. The medium of claim 27, wherein said proof sheet includes one or more thumbnail images representing one or more respective pages of the scan job.

29. The medium of claim 28, wherein said step of sending includes forwarding the scan job to a network.
